(19) United States
(12) Patent Application Publication
(10) Pub. No.: US 2024/0014895 A1
(43) Pub. Date: Jan. 11, 2024

(54) WAITING DURATION DETERMINATION METHOD AND APPARATUS

(71) Applicant: Spreadtrum Semiconductor (Nanjing) Co., Ltd., Nanjing (CN)

(72) Inventor: Zhenzhu LEI, Nanjing (CN)

(73) Assignee: Spreadtrum Semiconductor (Nanjing) Co., Ltd., Nanjing (CN)

(21) Appl. No.: 18/028,431

(22) PCT Filed: Aug. 30, 2021
(86) PCT No.: PCT/CN2021/115456

§ 371 Date: Mar. 24, 2023

(30) Foreign Application Priority Data
Sep. 25, 2020 (CN) 202011024147.6

(51) Int. Cl. H04B 7/185

(52) U.S. Cl. CPC H04B 7/18519; H04B 7/18547

(57) ABSTRACT

Embodiments of the present disclosure provide a waiting duration determination method, applied to a terminal. The method includes: receiving configuration information, where the configuration information includes N waiting durations corresponding to N location intervals of a satellite, and N is an integer greater than or equal to 2; and determining a target waiting duration from the N waiting durations based on ready-for-delivery information, where the target waiting duration is a waiting duration subsequent to sending the ready-for-delivery information and prior to monitoring response information corresponding to the ready-for-delivery information by the terminal.

This application claims priority to Chinese Patent Application No. 2020110241476, filed with China National Intellectual Property Administration on Sep. 25, 2020 and titled “WAITING DURATION DETERMINATION METHOD AND APPARATUS”, the contents of which are incorporated herein by reference in their entireties.

### TECHNICAL FIELD

The present application relates to the field of satellite communication technologies, and particularly to a waiting duration determination method and apparatus.

### BACKGROUND

In a random access procedure of a non-terrestrial network, after a terminal sends a random access message to a satellite, due to a long propagation delay between the terminal and the satellite, the terminal generally needs to start monitoring a random access response message subsequent to a preset waiting duration, that is, there is a preset time interval between a resource end position of a physical random access channel and a corresponding random access response window (RAR window) thereof.

Currently, in an earth-fixed beam (earth-fixed beam) scenario of the non-terrestrial network, since the distance between the terminal and the satellite varies with different time instants, the propagation delay between the terminal and the satellite also varies. In the prior art, a generality is to set the preset waiting duration to a fixed large value based on a maximum propagation delay between the terminal and the satellite. Setting the preset waiting duration to the fixed large value based on the maximum propagation delay will lead to monitoring a random access response within a random access response window by the terminal only after a long preset waiting duration, which thus results in a large random access delay for the terminal.

### SUMMARY

Embodiments of the present application provide a waiting duration determination method and apparatus. The present application is used to enable a target waiting duration to be adaptive to a propagation delay between a terminal and a satellite, thereby reducing a waiting duration of the terminal, and reducing a random access delay of the terminal.

In a first aspect, an embodiment of the present application provides a waiting duration determination method. The method is applied to a terminal and includes:

receiving configuration information, where the configuration information includes N waiting durations corresponding to N location intervals of a satellite, and N is an integer greater than or equal to 2; and

determining a target waiting duration from the N waiting durations based on ready-for-delivery information, where the target waiting duration is a waiting duration subsequent to sending the ready-for-delivery information and prior to monitoring response information corresponding to the ready-for-delivery information by the terminal.

In a possible design, the determining the target waiting duration from the N waiting durations based on the ready-for-delivery information includes: determining the target waiting duration from the N waiting durations based on first information of the ready-for-delivery information.

In a possible design, the first information is any of the following information:

first temporal information including a sending time of the ready-for-delivery information and a first receiving time of the configuration information;

second temporal information including a sending time of the ready-for-delivery information and a second receiving time of first indication information corresponding to the ready-for-delivery information, where the first indication information indicates a starting waiting duration corresponding to a starting index in the N waiting durations; and

second indication information corresponding to the ready-for-delivery information, where the second indication information is used to indicate the target waiting duration.

In a possible design, the first information is the first temporal information, and the configuration information further includes an update cycle; the determining the target waiting duration from the N waiting durations based on the first information of the ready-for-delivery information includes:

determining an update period corresponding to each waiting duration based on the first receiving time and the update cycle; and

determining the target waiting duration based on the sending time and the update period corresponding to each duration, where the sending time is within the update period corresponding to the waiting duration.

In a possible design, the first information is the second temporal information, and the configuration information further includes an update cycle; the determining the target waiting duration from the N waiting durations based on the first information of the ready-for-delivery information includes:

determining, based on the second receiving time and the update cycle, an update period corresponding to each waiting duration between the starting waiting duration corresponding to the starting index and an ending waiting duration, where the ending waiting duration is a last-ranked waiting duration of the N waiting durations ranked based on a ranking sequence; and

determining the target waiting duration based on the sending time and the update period corresponding to each waiting duration between the starting waiting duration and the ending waiting duration, where the sending time is within the update period corresponding to the target waiting duration.

In a possible design, the first indication information is included in any of the following information: a media access control signaling and a radio resource control signaling, where the media access control signaling and the radio resource control signaling are received after the terminal receives the configuration information.

In a possible design, the second indication information is included in any of the following information: a media access control signaling and downlink control information, where the media access control signaling and the downlink control information are received after the terminal receives the configuration information.

In a possible design, the configuration information is included in any of the following information: system broadcast information and a radio resource control signaling.

In a possible design, a ranking sequence of the N waiting durations corresponds to a ranking sequence of the N location intervals, and the ranking sequence of the N waiting durations corresponds to a motion trajectory of the satellite.

In a second aspect, an embodiment of the present application provides a waiting duration determination method. The method is applied to a base station and includes:

acquiring a location parameter corresponding to a terminal and an ephemeris parameter of a satellite;

determining configuration information based on the location parameter and the ephemeris parameter, where the configuration information includes N waiting durations corresponding to N location intervals of the satellite, and the N is an integer greater than or equal to 2; and

sending the configuration information to the terminal.

In a possible design, the determining the configuration information based on the location parameter and the ephemeris parameter includes:

acquiring satellite speed information and satellite orbit information in the ephemeris parameter;

determining the N waiting durations and a ranking sequence of the N waiting durations based on the location parameter, the satellite speed information and the satellite orbit information; and

determining the configuration information based on the N waiting durations and the ranking sequence of the N waiting durations.

In a possible design, the configuration information further includes an update cycle, and the update cycle is determined based on the satellite speed information and the satellite orbit information.

In a possible design, after the sending the configuration information to the terminal, further including: sending a media access control signaling or a radio resource control signaling to the terminal, where the media access control signaling and the radio resource control signaling include first indication information, and the first indication information indicates a starting waiting duration corresponding to a starting index in the N waiting durations.

In a possible design, after the sending the configuration information to the terminal, further including: sending a media access control signaling or downlink control information to the terminal, where the media access control signaling and the downlink control information include second indication information, and the second indication information is used to indicate a target waiting duration.

In a possible design, the configuration information is included in any of the following information: system broadcast information and a radio resource control signaling.

In a possible design, a ranking sequence of the N waiting durations corresponds to a ranking sequence of the N location intervals, and the ranking sequence of the N waiting durations corresponds to a motion trajectory of the satellite.

In a third aspect, an embodiment of the present application provides a waiting duration determination apparatus. The apparatus is applied to a terminal and includes a receiving module and a determining module, where:

the receiving module is configured to receive configuration information, where the configuration information includes N waiting durations corresponding to N location intervals of a satellite, and N is an integer greater than or equal to 2; and

the determining module is configured to determine a target waiting duration from the N waiting durations based on ready-for-delivery information, where the target waiting duration is a waiting duration subsequent to sending the ready-for-delivery information and prior to monitoring response information corresponding to the ready-for-delivery information by the terminal.

In a possible design, the determining module is specifically configured to: determine the target waiting duration from the N waiting durations based on first information of the ready-for-delivery information.

In a possible design, the first information is any of the following information:

first temporal information including a sending time of the ready-for-delivery information and a first receiving time of the configuration information;

second temporal information including a sending time of the ready-for-delivery information and a second receiving time of first indication information corresponding to the ready-for-delivery information, where the first indication information indicates a starting waiting duration corresponding to a starting index in the N waiting durations; and

second indication information corresponding to the ready-for-delivery information, where the second indication information is used to indicate the target waiting duration.

In a possible design, the first information is the first temporal information, and the configuration information further includes an update cycle; the determining module is specifically configured to:

determine an update period corresponding to each waiting duration based on the first receiving time and the update cycle; and

determine the target waiting duration based on the sending time and the update period corresponding to each duration, where the sending time is within the update period corresponding to the waiting duration.

In a possible design, the first information is the second temporal information, and the configuration information further includes an update cycle; the determining module is specifically configured to:

determine, based on the second receiving time and the update cycle, an update period corresponding to each waiting duration between the starting waiting duration corresponding to the starting index and an ending waiting duration, where the ending waiting duration is a last-ranked waiting duration of the N waiting durations ranked based on a ranking sequence; and

determine the target waiting duration based on the sending time and the update period corresponding to each waiting duration between the starting waiting duration and the ending waiting duration, where the sending time is within the update period corresponding to the target waiting duration.

In a possible design, the first indication information is included in any of the following information: a media access control signaling and a radio resource control signaling, where the media access control signaling and the radio resource control signaling are received after the terminal receives the configuration information.

In a possible design, the second indication information is included in any of the following information: a media access control signaling and downlink control information, where the media access control signaling and the downlink control information are received after the terminal receives the configuration information.

In a possible design, the configuration information is included in any of the following information: system broadcast information and a radio resource control signaling.

In a possible design, a ranking sequence of the N waiting durations corresponds to a ranking sequence of the N location intervals, and the ranking sequence of the N waiting durations corresponds to a motion trajectory of the satellite.

In a fourth aspect, an embodiment of the present application provides a waiting duration determination apparatus. The apparatus is applied to a base station and includes an acquiring module, a determining module and a sending module, where:

the acquiring module is configured to acquire a location parameter corresponding to a terminal;

the determining module is configured to determine configuration information based on the location parameter and an ephemeris parameter of a satellite, where the configuration information includes N waiting durations corresponding to N location intervals of the satellite, and the N is an integer greater than or equal to 2; and

the sending module is configured to send the configuration information to the terminal.

In a possible design, the determining module is specifically configured to:

acquire satellite speed information and satellite orbit information in the ephemeris parameter;

determine the N waiting durations and a ranking sequence of the N waiting durations based on the location parameter, the satellite speed information and the satellite orbit information; and

determine the configuration information based on the N waiting durations and the ranking sequence of the N waiting durations.

In a possible design, the configuration information further includes an update cycle, and the update cycle is determined based on the satellite speed information and the satellite orbit information.

In a possible design, the sending module, after sending the configuration information to the terminal, is further configured to: send a media access control signaling or a radio resource control signaling to the terminal, where the media access control signaling and the radio resource control signaling include first indication information, and the first indication information indicates a starting waiting duration corresponding to a starting index in the N waiting durations.

In a possible design, the sending module, after sending the configuration information to the terminal, is further configured to: send a media access control signaling or downlink control information to the terminal, where the media access control signaling and the downlink control information include second indication information, and the second indication information is used to indicate a target waiting duration.

In a possible design, the configuration information is included in any of the following information: system broadcast information and a radio resource control signaling.

In a possible design, a ranking sequence of the N waiting durations corresponds to a ranking sequence of the N location intervals, and the ranking sequence of the N waiting durations corresponds to a motion trajectory of the satellite.

In a fifth aspect, an embodiment of the present application provides a terminal, including: a memory, a processor and a computer program, where the computer program is stored in the memory, and the processor runs the computer program to execute the method described above in any item of the first aspect.

In a sixth aspect, an embodiment of the present application provides a base station, including: a memory, a processor and a computer program, where the computer program is stored in the memory, and the processor runs the computer program to execute the method described above in any item of the second aspect.

In a seventh aspect, an embodiment of the present application provides a computer-readable storage medium applied to a terminal. The computer-readable storage medium includes a computer program which, when being executed by a processor, implements the method described above in any item of the first aspect.

In an eighth aspect, an embodiment of the present application provides a computer-readable storage medium applied to a base station. The computer-readable storage medium includes a computer program which, when being executed by a processor, implements the method described above in any item of the second aspect.

Embodiments of the present application provide a waiting duration determination method and apparatus. The method includes: a terminal determining, based on a second receiving time of first indication information and an update cycle, an update period corresponding to each waiting duration between a starting waiting duration corresponding to a starting index and an ending waiting duration, and then the terminal determining a target waiting duration based on a sending time of ready-for-delivery information and the update period corresponding to each waiting duration between the starting waiting duration and the ending waiting duration. The target waiting duration determined from the N waiting durations by the terminal based on the ready-for-delivery information can be adaptive to a propagation delay between a terminal and a satellite, thereby reducing a waiting duration of the terminal, and reducing a random access delay of the terminal.

### BRIEF DESCRIPTION OF DRAWINGS

FIG. 1 is a schematic diagram of an application scenario of a waiting duration determination method according to an embodiment of the present application.

FIG. 2 is a first schematic flowchart of a waiting duration determination method according to an embodiment of the present application.

FIG. 3 is a second schematic flowchart of a waiting duration determination method according to an embodiment of the present application.

FIG. 4 is a third schematic flowchart of a waiting duration determination method according to an embodiment of the present application.

FIG. 5 is a fourth schematic flowchart of a waiting duration determination method according to an embodiment of the present application.

FIG. 6 is a fifth schematic flowchart of a waiting duration determination method according to an embodiment of the present application.

FIG. 7 is a schematic structural diagram of a waiting duration determination apparatus according to an embodiment of the present application.

FIG. 8 is a schematic structural diagram of another waiting duration determination apparatus according to an embodiment of the present application.

FIG. 9 is a schematic structural diagram of hardware of a terminal according to an embodiment of the present application.

FIG. 10 is a schematic structural diagram of hardware of a base station according to an embodiment of the present application.

### DESCRIPTION OF EMBODIMENTS

In order to describe objectives, technical solutions, and advantages of embodiments of the present application more clearly, the technical solutions in the embodiments of the present application will be described hereunder clearly and comprehensively with reference to the accompanying drawings in the present application. Obviously, the described embodiments are only a part of embodiments of the present invention, rather than all embodiments thereof. All other embodiments obtained by persons of ordinary skill in the art based on the embodiments of the present invention without any creative effort shall fall into the protection scope of the present invention.

The terms such as “first”, “second”, “third” and “fourth” (if any) in the specification and/or the claims as well as the described accompany drawings of the present invention are used to distinguish similar objects, but not intended to describe a specific order or sequence. Moreover, the terms such as “include” and “have” and any variation thereof are intended to cover a non-exclusive inclusion, e.g., processes, methods, systems, products or devices that encompass a series of steps or units are not necessarily limited to those steps or units that are explicitly listed, but may include other steps or units that are not explicitly listed or inherent to these processes, methods, products or devices.

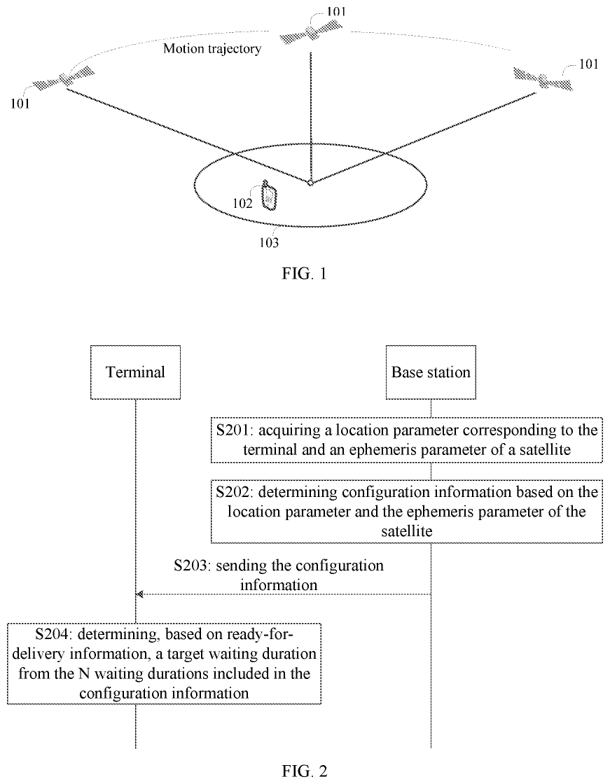

FIG. 1 is a schematic diagram of an application scenario of a waiting duration determination method according to an embodiment of the present application. As shown in FIG. 1, an earth-fixed beam scenario in a non-terrestrial network (NTN) may include: a satellite 101 and a terminal 102. Among them, the terminal 102 is located within a coverage range 103 of a beam/cell corresponding to the satellite 101.

The satellite 101 may be a base station corresponding to the terminal 102, or a relay device between the terminal 102 and the base station corresponding to the terminal 102 (that is, the data transmitted between the terminal 102 and the base station corresponding to the terminal 102 is forwarded through the satellite 101).

During an operation of the satellite 101, a distance between the satellite 101 and the terminal 102 varies with different time instants, and a propagation delay between the satellite 101 and the terminal 102 varies with a change of the distance between the satellite 101 and the terminal 102. As shown in FIG. 1, when the distance between the satellite 101 and the terminal 102 is short, the propagation delay is minimal; when the distance between the satellite 101 and the terminal 102 is long, the propagation delay has a maximum value.

In the prior art, setting a preset waiting duration to a fixed large value based on the maximum propagation delay would result in a relatively long preset waiting duration for a terminal, which in turn leads to a large random access delay for the terminal. In practice, since the propagation delay between the terminal and the satellite is variable, it is desirable to take into consideration a waiting duration determination mechanism adaptive to a change of the propagation delay, for this reason, the present application provides a waiting duration determination method enabling the terminal 102 to determine a target waiting duration adaptive to the change of the propagation delay, thereby achieving the objective of reducing a random access delay of the terminal 102.

Hereinafter, the technical solutions shown in the present application will be described in detail with specific embodiments. It should be noted that the following specific embodiments may be combined with each other, and for the same or similar contents, repetitive description will be omitted in different embodiments.

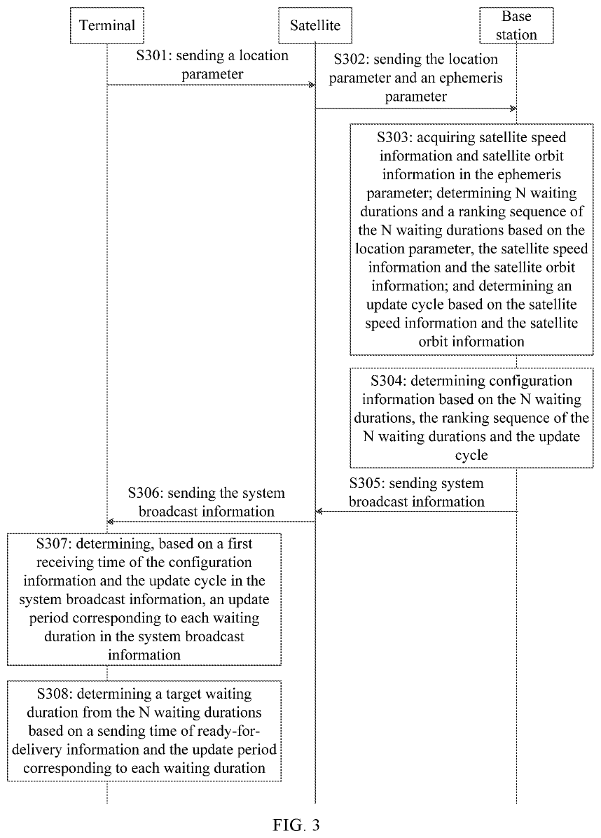

FIG. 2 is a first schematic flowchart of a waiting duration determination method according to an embodiment of the present application. As shown in FIG. 2, the waiting duration determination method provided in the embodiment includes the following.

S201: a base station acquires a location parameter corresponding to a terminal and an ephemeris parameter of a satellite.

Optionally, the base station may be a satellite or a ground base station. For example, when the base station is a ground base station, the satellite is a relay device between the base station and the terminal.

Optionally, the terminal may send an uplink reference signal to the base station, enabling the base station to determine, based on the uplink reference signal, a location parameter corresponding to the terminal; alternatively, the terminal may report the location parameter to the base station.

Optionally, the location parameter corresponding to the terminal can be a cell reference point corresponding to a cell where the terminal is located. The cell reference point is predefined, that is, a reference point of a cell/beam corresponding to the satellite is predefined when deploying the network.

Optionally, the ephemeris parameter of the satellite generally includes satellite speed information, satellite orbit information, ephemeris reference time, eccentricity, etc.

S202: the base station determines configuration information based on the location parameter and the ephemeris parameter of the satellite, where the configuration information includes N waiting durations corresponding to N location intervals of the satellite, and the N is an integer greater than or equal to 2.

Optionally, the ephemeris parameter of the satellite generally includes satellite speed information, satellite orbit information, ephemeris reference time, eccentricity, etc.

Specifically, it is possible to determine N waiting durations and a ranking sequence of the N waiting durations based on the location parameter, the satellite speed information and the satellite orbit information; and

determine the configuration information based on the N waiting durations and the ranking sequence of the N waiting durations.

In the configuration information, the N waiting durations are ranked based on the above-described ranking sequence.

In one possible design, the ranking sequence of the N waiting durations corresponds to a ranking sequence of the N location intervals of the satellite, and the ranking sequence of the N waiting durations corresponds to a motion trajectory of the satellite.

S203: the base station sends the configuration information to the terminal.

Optionally, when the base station is a satellite, the base station can directly send the configuration information to the terminal; when the base station is a ground base station, the base station can send the configuration information to the terminal through the satellite.

Optionally, the configuration information may be included in any of the following information: system broadcast information (SIB), a radio resource control signaling (an RRC-specific signaling). That is, the base station may send system broadcast information or a radio resource control signaling to the terminal, where the system broadcast information and the radio resource control signaling include the configuration information therein.

S204: the terminal determines a target waiting duration from the N waiting durations based on ready-for-delivery information, where the target waiting duration is a waiting duration subsequent to sending the ready-for-delivery information and prior to monitoring response information corresponding to the ready-for-delivery information by the terminal.

Optionally, the ready-for-delivery information may be a random access message sent to the base station (either directly or via a satellite) by the terminal (in a random access procedure between the terminal and the base station); the response information may be a random access response sent to the terminal (either directly or via a satellite) by the base station (after receiving the ready-for-delivery information).

Specifically, it is possible to determine the target waiting duration from the N waiting durations based on first information of the ready-for-delivery information, where the first information is any of the following information:

first temporal information including a sending time of the ready-for-delivery information and a first receiving time of the configuration information;

second temporal information including a sending time of the ready-for-delivery information and a second receiving time of first indication information corresponding to the ready-for-delivery information, where the first indication information indicates a starting waiting duration corresponding to a starting index in the N waiting durations; and

second indication information corresponding to the ready-for-delivery information, where the second indication information is used to indicate the target waiting duration.

The present embodiment provides a waiting duration determination method that includes: a base station acquiring a location parameter corresponding to a terminal and an ephemeris parameter of a satellite; the base station determining configuration information based on the location parameter and the ephemeris parameter, where the configuration information includes N waiting durations corresponding to N location intervals of the satellite, and the N is an integer greater than or equal to 2; the base station sending the configuration information to the terminal; the terminal determining a target waiting duration from the N waiting durations based on ready-for-delivery information. In the above-described method, the target waiting duration determined from the N waiting durations by the terminal based on the ready-for-delivery information can be adaptive to a propagation delay between a terminal and a satellite, thereby reducing a waiting duration of the terminal, and reducing a random access delay of the terminal.

On the basis of the above-described embodiment, the waiting duration determination method provided in the embodiment of the present application will be further explained hereunder in conjunction with an embodiment of FIG. 3 by taking an example where the base station is a satellite on the ground and the first information is first temporal information.

FIG. 3 is a second schematic flowchart of a waiting duration determination method according to an embodiment of the present application. As shown in FIG. 3, the waiting duration determination method provided in the embodiment includes the following.

S301: a terminal sends a location parameter to a satellite.

S302: the satellite sends the location parameter and an ephemeris parameter to the base station, where the ephemeris parameter includes satellite speed information and satellite orbit information.

Optionally, the satellite may send the location parameter and the ephemeris parameter to the base station, separately.

For example, the satellite may send the ephemeris parameter to the base station after sending the location parameter to the base station.

For example, if the satellite receives the location parameter after sending the ephemeris parameter to the base station, then the satellite sends the location parameter to the base station. Optionally, the satellite periodically sends the ephemeris parameter to the base station.

S303: the base station acquires the satellite speed information and the satellite orbit information, determines N waiting durations and a ranking sequence of the N waiting durations based on the location parameter, the satellite speed information and the satellite orbit information, and determines an update cycle based on the satellite speed information and the satellite orbit information.

In practical applications, the faster the speed of the satellite, the faster the distance between the satellite and the location of the terminal or the cell reference point would change, and the shorter the update cycle.

Optionally, the ephemeris parameter includes the satellite speed information and the satellite orbit information, and the base station can directly obtain the satellite speed information and the satellite orbit information from the ephemeris parameter.

Optionally, the ephemeris parameter includes code information respectively corresponding to the satellite speed information and the satellite orbit information, and the base station can obtain the satellite speed information and the satellite orbit information after performing conversion processing on the code information respectively corresponding to the satellite speed information and the satellite orbit information. The conversion processing may include decoding processing, decryption processing, or the like.

S304: the base station determines configuration information based on the N waiting durations, the ranking sequence of the N waiting durations and the update cycle, where the configuration information includes the update cycle and the N waiting durations ranked based on the ranking sequence, the N waiting durations correspond to N location intervals of the satellite, the ranking sequence of the N waiting durations corresponds to a ranking sequence of the N location intervals, the ranking sequence of the N waiting durations corresponds to a motion trajectory of the satellite, and N is an integer greater than or equal to 2.

Optionally, the configuration information is obtained by ranking the N waiting durations in the above-described ranking sequence, and performing combination processing on the ranked N waiting durations and the update cycle.

Optionally, the update cycle may be in milliseconds (ms), subframes, frames, slots, etc. For example, when the update cycle is in ms, the update cycle may be sized to 1, 2, 3, or the like. Specifically, the update cycle is not limited in the present application in terms of its specific magnitude.

For example, when N=5, the five waiting durations ranked based on the ranking sequence are respectively T1, T2, T3, T4 and T5. In practical applications, the values of T1, T2, T3, T4 and T5 are determined based on an actual design requirement, which is not limited in the present application.

Optionally, the five waiting durations in the configuration information may exist in the form of a set {T1, T2, T3, T4, T5}.

S305: the base station sends system broadcast information to the satellite, where the system broadcast information includes the configuration information.

Optionally, the base station can also send a radio resource control signaling to the satellite, where the radio resource control signaling includes the configuration information.

S306: the satellite sends the system broadcast information to the terminal.

Optionally, if the base station sends system broadcast information to the satellite, the satellite may send the system broadcast information to the terminal or send a radio resource control signaling to the terminal, where the radio resource control signaling includes the configuration information.

Optionally, if the base station sends a radio resource control signaling to the satellite, the satellite may send the radio resource control signaling to the terminal or send system broadcast information to the terminal, where the system broadcast information includes the configuration information.

S307: the terminal determines an update period corresponding to each waiting duration based on a first receiving time of the configuration information and the update cycle, where the first receiving information is included in first temporal information of ready-for-delivery information, and the first temporal information also includes a sending time of the ready-for-delivery information.

Optionally, the first receiving time may be the same as or may be different from a receiving time of the system broadcast information. For example, when the first receiving time is different from the receiving time of the system broadcast information, the first receiving time can be a time instant at which the configuration information is acquired from the system broadcast information.

For example, when the first receiving time is 00:00 ms, the update cycle is 1 ms, and the configuration information includes three waiting durations (T1, T2 and T3, respectively), then T1˜T3 respectively correspond to update periods 00:00 ms˜01:00 ms, 01:00 ms˜02:00 ms and 02:00 ms˜03:00 ms.

S308: the terminal determines a target waiting duration from the N waiting durations based on the sending time of the ready-for-delivery information and the update period corresponding to each waiting duration, where the sending time is within the update period corresponding to the target waiting duration.

On the basis of S307, for example, when the sending time is 01:05 ms, T2 among T1, T2 and T3 can be determined as the target waiting duration since the sending time 01:05 ms is within the update period 01:00 ms-02:00 ms corresponding to T2.

The present embodiment provides a waiting duration determination method that includes: a terminal determining an update period corresponding to each waiting duration based on a first receiving time and an update cycle, and then determining a target waiting duration from N waiting durations based on a sending time of ready-for-delivery information and an update period corresponding to each waiting duration. In the above-described method, the target waiting duration determined from the N waiting durations by the terminal based on the ready-for-delivery information can be adaptive to a propagation delay between a terminal and a satellite, thereby reducing a waiting duration of the terminal, and reducing a random access delay of the terminal.

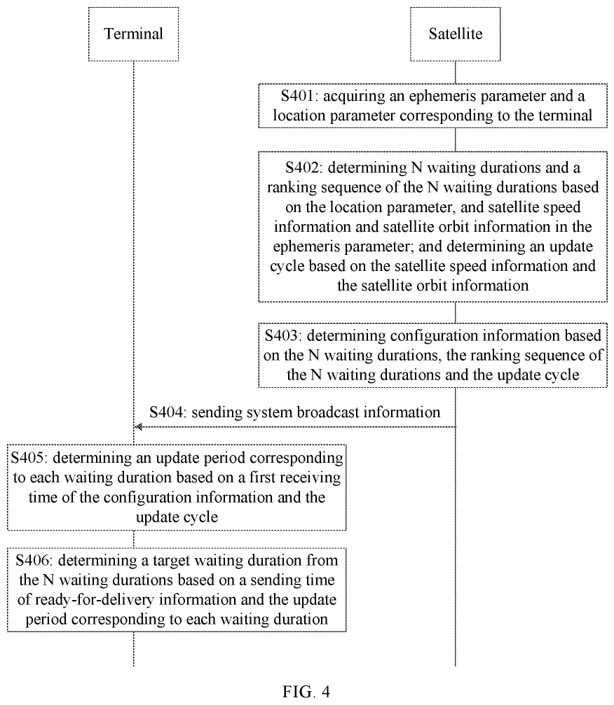

On the basis of the above-described embodiment, the waiting duration determination method provided in the embodiment of the present application will be further explained hereunder in conjunction with an embodiment of FIG. 4 by taking an example where the base station is a satellite and the first information is first temporal information.

FIG. 4 is a third schematic flowchart of a waiting duration determination method according to an embodiment of the present application. As shown in FIG. 4, the waiting duration determination method provided in the embodiment includes the following.

S401: a satellite acquires a location parameter corresponding to a terminal and an ephemeris parameter, where the ephemeris parameter includes satellite speed information and satellite orbit information.

S402: the satellite determines N waiting durations and a ranking sequence of the N waiting durations based on the location parameter, the satellite speed information and the satellite orbit information, and determines an update cycle based on the satellite speed information and the satellite orbit information.

In practical applications, the faster the speed of the satellite, the faster the distance between the satellite and the location of the terminal or the cell reference point would change, and the shorter the update cycle.

S403: the satellite determines configuration information based on the N waiting durations, the ranking sequence of the N waiting durations and the update cycle, where the configuration information includes the update cycle and the N waiting durations ranked based on the ranking sequence, the N waiting durations correspond to N location intervals of the satellite, the ranking sequence of the N waiting durations corresponds to a ranking sequence of the N location intervals, the ranking sequence of the N waiting durations corresponds to a motion trajectory of the satellite, and N is an integer greater than or equal to 2.

S404: the satellite sends system broadcast information to the terminal, where the system broadcast information includes the configuration information.

Optionally, the satellite may also send a radio resource control signaling to the terminal, where the radio resource control signaling includes the configuration information.

S405: the terminal determines an update period corresponding to each waiting duration based on a first receiving time of the configuration information and the update cycle, where the first receiving information is included in first temporal information of ready-for-delivery information, and the first temporal information also includes a sending time of the ready-for-delivery information.

S406: the terminal determines a target waiting duration from the N waiting durations based on the sending time of the ready-for-delivery information and the update period corresponding to each waiting duration, where the sending time is within the update period corresponding to the target waiting duration.

The present embodiment provides a waiting duration determination method that includes: a terminal determining an update period corresponding to each waiting duration based on a first receiving time and an update cycle, and determining a target waiting duration from N waiting durations based on a sending time of ready-for-delivery information and an update period corresponding to each waiting duration. In the above-described method, the target waiting duration determined from the N waiting durations by the terminal based on the ready-for-delivery information can be adaptive to a propagation delay between a terminal and a satellite, thereby reducing a waiting duration of the terminal, and reducing a random access delay of the terminal.

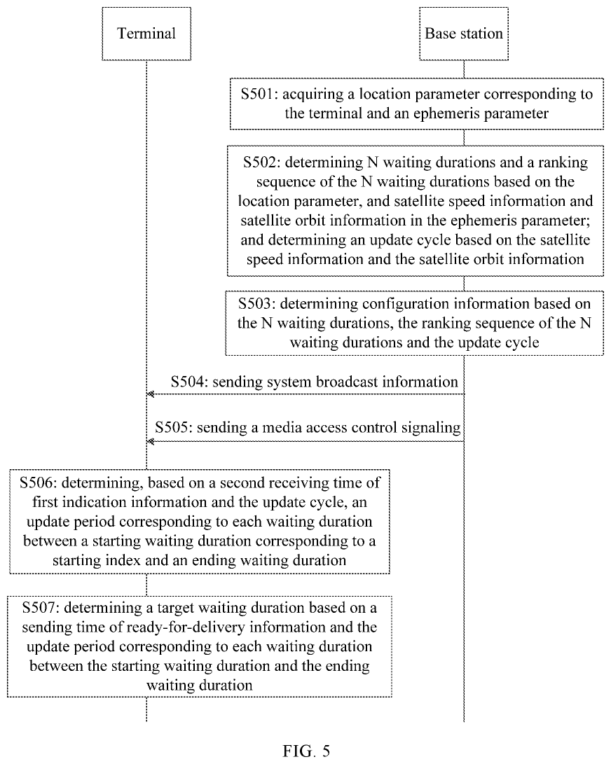

On the basis of the above-described embodiment, the waiting duration determination method provided in the embodiment of the present application will be further explained hereunder in conjunction with an embodiment of FIG. 5 by taking an example where the first information is second temporal information. It should be noted that, in the embodiment of FIG. 5, the base station may be a satellite or a ground base station, and when the base station is a ground base station, the data transmitted between the base station and the terminal is forwarded through the satellite.

FIG. 5 is a fourth schematic flowchart of a waiting duration determination method according to an embodiment of the present application. As shown in FIG. 5, the waiting duration determination method provided in the embodiment includes the following.

S501: a base station acquires a location parameter corresponding to a terminal and an ephemeris parameter, where the ephemeris parameter includes satellite speed information and satellite orbit information.

S502: the base station determines N waiting durations and a ranking sequence of the N waiting durations based on the location parameter, the satellite speed information and the satellite orbit information, and determines an update cycle based on the satellite speed information and the satellite orbit information.

S503: the base station determines configuration information based on the N waiting durations, the ranking sequence of the N waiting durations and the update cycle, where the configuration information includes the N waiting durations and the update cycle, the N waiting durations correspond to N location intervals of the satellite, the ranking sequence of the N waiting durations corresponds to a ranking sequence of the N location intervals, the ranking sequence of the N waiting durations corresponds to a motion trajectory of the satellite, and N is an integer greater than or equal to 2.

S504: the base station sends system broadcast information to the terminal, where the system broadcast information includes the configuration information.

Optionally, the base station may also send a radio resource control signaling to the terminal, where the radio resource control signaling includes the configuration information.

S505: the base station sends a media access control signaling to the terminal, where the media access control signaling includes first indication information, and the first indication information indicates a starting waiting duration corresponding to a starting index in the N waiting durations.

Optionally, when the base station sends a radio resource control signaling including the configuration information to the terminal, the radio resource control signaling may include the first indication information.

Optionally, after the base station sends a radio resource control signaling including the configuration information to the terminal, the base station may also send another radio resource control signaling including the first indication information to the terminal.

Optionally, the first indication information may be a starting index, or may be indication information including the starting index.

Specifically, the N waiting durations have their own corresponding indexes, and the indexes corresponding to the N waiting durations increase sequentially with the ranking sequence of the N waiting durations.

For example, when N=3 and the three waiting durations are respectively T1, T2 and T3 in sequence, T1—T3 respectively correspond to indexes 0, 1 and 2 in sequence; T1—T3 respectively correspond to indexes 1,2 and 3 in sequence.

For example, when T1˜T2 respectively correspond to indexes 0-2 in sequence, the starting waiting duration corresponding to the starting index is T2 if the starting index is 1.

S506: the terminal determines, based on a second receiving time of the first indication information and the update cycle, an update period corresponding to each waiting duration between a starting waiting duration corresponding to a starting index and an ending waiting duration, where the ending waiting duration is a last-ranked waiting duration of the N waiting durations ranked based on a ranking sequence, and where the second receiving time is included in second temporal information, and the second temporal information further includes a sending time of ready-for-delivery information.

Optionally, after receiving the system broadcast information, the terminal may store the configuration information first; and after receiving the media access control signaling, the terminal may proceed with execution of S506.

Optionally, the second receiving time of the first indication information may be a time instant at which the terminal receives the media access control signaling.

Optionally, the ending waiting duration generally has an ending index, which is a largest index of indexes corresponding to the N waiting durations.

For example, when N=4, the four waiting durations are respectively T1, T2, T3 and T4 in sequence, and T1—T4 respectively correspond to indexes 0-3, then the ending waiting duration is T4, and T4 corresponds to an ending index of 3.

For example, when N=4 and the four waiting durations are respectively T1, T2, T3 and T4 in sequence, the ending waiting duration is T4; when T1—T4 respectively correspond to indexes if the starting index is 1, the starting waiting duration corresponding to the starting index is T2, and the waiting durations between the starting waiting duration corresponding to the starting index and the ending waiting duration are respectively T2, T3 and T4 in sequence.

For example, when the second receiving time is 00:00 ms, the update cycle is 1 ms, the four waiting durations are respectively T1, T2, T3 and T4 in sequence, and the starting index is 1 (the corresponding starting waiting duration is T2), then T2˜T4 respectively correspond to update periods 00:00 ms-01:00 ms, 01:00 ms-02:00 ms and 02:00 ms-03:00 ms in sequence.

S507: the terminal determines a target waiting duration based on the sending time of the ready-for-delivery information and the update period corresponding to each waiting duration between the starting waiting duration and the ending waiting duration, where the sending time is within the update period corresponding to the target waiting duration.

On the basis of S506, for example, when the sending time is 01:05 ms, T3 among T1, T2 and T3 can be determined as the target waiting duration since the sending time 01:05 ms is within the update period 01:00 ms-02:00 ms corresponding to T3.

The present embodiment provides a waiting duration determination method that includes: a terminal determining, based on a second receiving time of first indication information and an update cycle, an update period corresponding to each waiting duration between a starting waiting duration corresponding to a starting index and an ending waiting duration, and then the terminal determining a target waiting duration based on a sending time of ready-for-delivery information and the update period corresponding to each waiting duration between the starting waiting duration and the ending waiting duration. In the above-described method, the target waiting duration determined from the N waiting durations by the terminal based on the ready-for-delivery information can be adaptive to a propagation delay between a terminal and a satellite, thereby reducing a waiting duration of the terminal, and reducing a random access delay of the terminal.

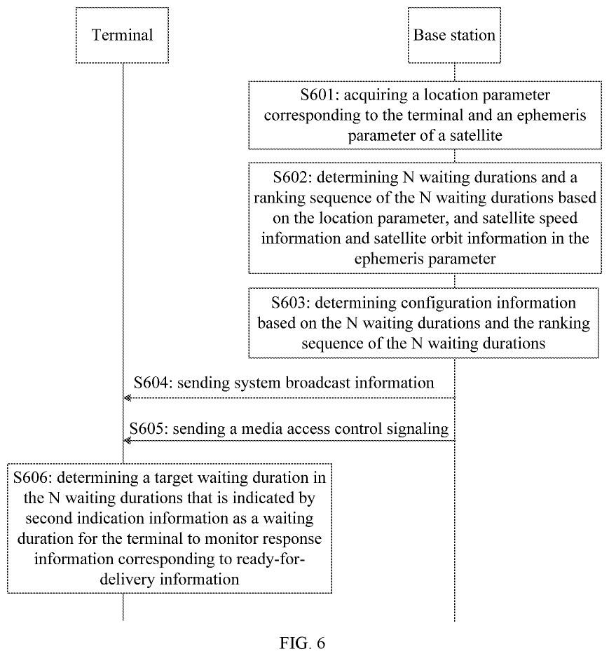

On the basis of the above-described embodiment, the waiting duration determination method provided in the embodiment of the present application will be further explained hereunder in conjunction with an embodiment of FIG. 6 by taking an example where the first information is second indication information corresponding to the ready-for-delivery information. It should be noted that, in the embodiment of FIG. 6, the base station may be a satellite or a ground base station, and when the base station is a ground base station, the data transmitted between the base station and the terminal is forwarded through the satellite.

FIG. 6 is a fifth schematic flowchart of a waiting duration determination method according to an embodiment of the present application. As shown in FIG. 6, the waiting duration determination method provided in the embodiment includes the following.

S601: a base station acquires a location parameter corresponding to a terminal and an ephemeris parameter of a satellite, where the ephemeris parameter includes satellite speed information and satellite orbit information.

S602: the base station determines N waiting durations and a ranking sequence of the N waiting durations based on the location parameter, the satellite speed information and the satellite orbit information.

S603: the base station determines configuration information based on the N waiting durations and the ranking sequence of the N waiting durations, where the configuration information includes the N waiting durations, the N waiting durations correspond to N location intervals of the satellite, the ranking sequence of the N waiting durations corresponds to a ranking sequence of the N location intervals, the ranking sequence of the N waiting durations corresponds to a motion trajectory of the satellite, and N is an integer greater than or equal to 2.

S604: the base station sends system broadcast information to the terminal, where the system broadcast information includes the configuration information.

Optionally, the base station sends a radio resource control signaling to the terminal, where the radio resource control signaling includes the configuration information.

S605: the base station sends a media access control signaling to the terminal, where the media access control signaling includes second indication information, and the second indication information is used to indicate a target waiting duration.

It should be noted that the base station, after sending the system broadcast information or the media access control signaling to the terminal, can send a media access control signaling to the terminal.

Optionally, for a random access procedure triggered by a physical downlink control channel (Physical Downlink Control Channel, PDCCH) order, the base station, after sending the system broadcast information or the media access control signaling to the terminal, can also send downlink control information to the terminal, where the downlink control information includes the second indication information.

Optionally, a dedicated bit field can be set in the DCI to write the second indication information. For example, the second indication information can be written to a position length of 2 bits in the DCI.

S606: the terminal determines the target waiting duration in the N waiting durations that is indicated by the second indication information as a waiting duration for the terminal to monitor response information corresponding to ready-for-delivery information.

For example, when N=3 and the three waiting durations are respectively T1, T2 and T3 in sequence, T1˜T3 respectively correspond to indexes 0, 1 and 2 in sequence; if the second indication information is a target index 1, the target waiting duration T2 in T1 T2, and T3 that corresponds to the target index 1 is determined as a duration for the terminal to monitor the response information corresponding to the ready-for-delivery information (that is, a final desired target waiting duration).

In the present embodiment, a terminal determines a target waiting duration in N waiting durations that is indicated by second indication information as a waiting duration for the terminal to monitor response information corresponding to ready-for-delivery information (that is, a target waiting duration), so that the determined target waiting duration can be adaptive to a propagation delay between a terminal and a satellite, thereby reducing a waiting duration of the terminal, and reducing a random access delay of the terminal.

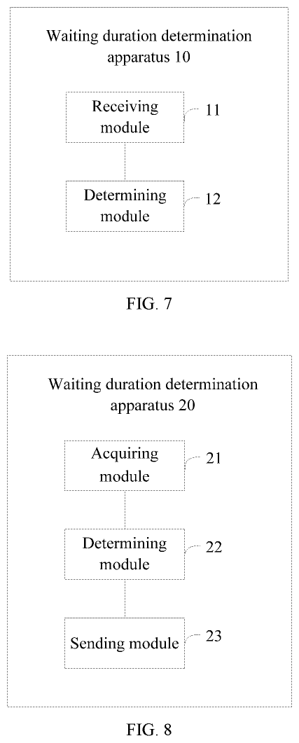

FIG. 7 is a schematic structural diagram of a waiting duration determination apparatus according to an embodiment of the present application. The waiting duration determination apparatus 10 is provided in a terminal, and the waiting duration determination apparatus 10 can be implemented by combing software and/or hardware. As shown in FIG. 7, the waiting duration determination apparatus 10 includes a receiving module 11 and a determining module 12.

The receiving module 11 is configured to receive configuration information, where the configuration information includes N waiting durations corresponding to N location intervals of a satellite, and N is an integer greater than or equal to 2.

The determining module 12 is configured to determine a target waiting duration from the N waiting durations based on ready-for-delivery information, where the target waiting duration is a waiting duration subsequent to sending the ready-for-delivery information and prior to monitoring response information corresponding to the ready-for-delivery information by the terminal.

The waiting duration determination apparatus 10 provided in the embodiment can be used to execute the method performed by the terminal in the above method embodiments. It can be implemented using the similar principle and produce the similar technical effect, and details will not be described here again.

In a possible design, the determining module 12 is specifically configured to: determine the target waiting duration from the N waiting durations based on first information of the ready-for-delivery information.

In a possible design, the first information is any of the following information: first temporal information including a sending time of the ready-for-delivery information and a first receiving time of the configuration information; second temporal information including a sending time of the ready-for-delivery information and a second receiving time of first indication information corresponding to the ready-for-delivery information, where the first indication information indicates a starting waiting duration corresponding to a starting index in the N waiting durations; and second indication information corresponding to the ready-for-delivery information, where the second indication information is used to indicate the target waiting duration.

In a possible design, the first information is the first temporal information, and the configuration information further includes an update cycle; the determining module 12 is specifically configured to: determine an update period corresponding to each waiting duration based on the first receiving time and the update cycle; and determine the target waiting duration based on the sending time and the update period corresponding to each duration, where the sending time is within the update period corresponding to the waiting duration.

In a possible design, the first information is the second temporal information, and the configuration information further includes an update cycle; the determining module 12 is specifically configured to: determine, based on the second receiving time and the update cycle, an update period corresponding to each waiting duration between the starting waiting duration corresponding to the starting index and an ending waiting duration, where the ending waiting duration is a last-ranked waiting duration of the N waiting durations ranked based on a ranking sequence; and determine the target waiting duration based on the sending time and the update period corresponding to each waiting duration between the starting waiting duration and the ending waiting duration, where the sending time is within the update period corresponding to the target waiting duration.

In a possible design, the first indication information is included in any of the following information: a media access control signaling and a radio resource control signaling, where the media access control signaling and the radio resource control signaling are received after the terminal receives the configuration information.

In a possible design, the second indication information is included in any of the following information: a media access control signaling and downlink control information, where the media access control signaling and the downlink control information are received after the terminal receives the configuration information.

In a possible design, the configuration information is included in any of the following information: system broadcast information and a radio resource control signaling.

In a possible design, a ranking sequence of the N waiting durations corresponds to a ranking sequence of the N location intervals, and the ranking sequence of the N waiting durations corresponds to a motion trajectory of the satellite.

FIG. 8 is a schematic structural diagram of another waiting duration determination apparatus based on an embodiment of the present application. The waiting duration determination apparatus 20 is provided in a satellite, and the waiting duration determination apparatus 20 can be implemented by combing software and/or hardware. As shown in FIG. 8, the waiting duration determination apparatus 20 includes an acquiring module 21, a determining module 22 and a sending module 23.

The acquiring module 21 is configured to acquire a location parameter corresponding to a terminal and an ephemeris parameter of a satellite.

The determining module 22 is configured to determine configuration information based on the location parameter and the ephemeris parameter, where the configuration information includes N waiting durations corresponding to N location intervals of the satellite, and the N is an integer greater than or equal to 2.

The sending module 23 is configured to send the configuration information to the terminal.

The waiting duration determination apparatus 20 provided in the embodiment can be used to execute the method performed by the satellite in the above method embodiments. It can be implemented using the similar principle and produce the similar technical effect, and details will not be described here again.

In a possible design, the determining module 22 is specifically configured to: acquire satellite speed information and satellite orbit information in the ephemeris parameter; determine the N waiting durations and a ranking sequence of the N waiting durations based on the location parameter, the satellite speed information and the satellite orbit information; and

determine the configuration information based on the N waiting durations and the ranking sequence of the N waiting durations.

In a possible design, the configuration information further includes an update cycle, and the update cycle is determined based on the satellite speed information and the satellite orbit information.

In a possible design, the sending module 23, after sending the configuration information to the terminal, is further configured to: send a media access control signaling or a radio resource control signaling to the terminal, where the media access control signaling and the radio resource control signaling include first indication information, and the first indication information indicates a starting waiting duration corresponding to a starting index in the N waiting durations.

In a possible design, the sending module 23, after sending the configuration information to the terminal, is further configured to: send a media access control signaling or downlink control information to the terminal, where the media access control signaling and the downlink control information include second indication information, and the second indication information is used to indicate a target waiting duration.

In a possible design, the configuration information is included in any of the following information: system broadcast information and a radio resource control signaling.

In a possible design, a ranking sequence of the N waiting durations corresponds to a ranking sequence of the N location intervals, and the ranking sequence of the N waiting durations corresponds to a motion trajectory of the satellite.

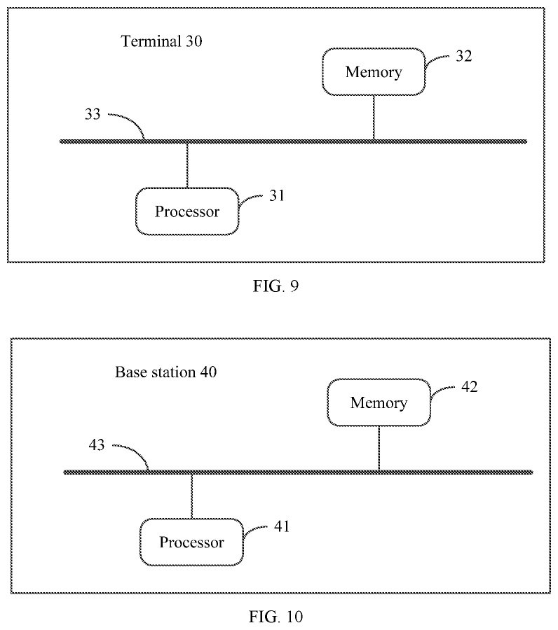

FIG. 9 is a schematic structural diagram of hardware of a terminal according to an embodiment of the present application. As shown in FIG. 9, the terminal 30 in the embodiment includes a processor 31 and a memory 32. The memory 32 is configured to store a computer program; the processor 31 is configured to execute the computer program stored in the memory so as to implement the method that can executed by the terminal in the above method embodiments. For details, reference may be made to relevant descriptions in the foregoing method embodiments.

Optionally, the memory 32 may be either standalone or integrated with the processor 31.

When the memory 32 is a device independent of the processor 31, the terminal 30 may also include a bus 33 for connecting the memory 32 and the processor 31.

The terminal 30 provided in the embodiment can be used to perform the method performed by the terminal in any of the above method embodiments. It can be implemented using the similar principle and produce the similar technical effect. Detailed description will be omitted in this embodiment.

An embodiment of the present application provides a computer-readable storage medium applied to a terminal. The computer-readable storage medium includes a computer program which, when being executed by a processor, implements the method that can be executed by the terminal in any of the foregoing method embodiments.

FIG. 10 is a schematic structural diagram pf hardware of a base station according to an embodiment of the present application. As shown in FIG. 10, the base station 40 in the embodiment includes a processor 41 and a memory 42. The memory 42 is configured to store a computer program; the processor 41 is configured to execute the computer program stored in the memory so as to implement the method that can executed by the base station in the above method embodiments. For details, reference may be made to relevant descriptions in the foregoing method embodiments.

Optionally, the memory 42 may be either standalone or integrated with the processor 41.

When the memory 42 is a device independent of the processor 41, the base station 40 may also include a bus 43 for connecting the memory 42 and the processor 41.

The base station 40 provided in the embodiment can be used to perform the method performed by the base station in any of the above method embodiments. It can be implemented using the similar principle and produce the similar technical effect. Detailed description will be omitted in this embodiment.

An embodiment of the present application provides a computer-readable storage medium applied to a base station. The computer-readable storage medium includes a computer program which, when being executed by a processor, implements the method that can be executed by the base station in any of the foregoing method embodiments.

In several embodiments provided in the embodiments of the present application, it should be understood that the disclosed device and method may be implemented in other manners. For example, the described apparatus embodiments are merely exemplary. For example, the division of modules is merely division of logical functions and there may be other divisions in actual implementations. For example, a plurality of modules may be combined or integrated into another system, or some features may be ignored or not performed. In addition, the mutual couplings or direct couplings or communication connections shown or discussed herein may be implemented through some interfaces. The indirect couplings or communication connections between the apparatuses or modules may be implemented in electronic, mechanical, or other forms.

The modules described as separate parts may or may not be physically separate, and parts displayed as modules may or may not be physical units, that is, they may be located in one position, or may be distributed on a plurality of network units. A part or all of the modules may be selected based on actual needs to achieve the objectives of the solutions of the embodiments.

In addition, functional modules in the embodiments of the present application may be integrated into one processing unit, or each of the modules may exist alone physically, or two or more modules may be integrated into one unit. The integrated module may be implemented in a form of hardware, or may be implemented in a form of a hardware plus software functional unit.

The integrated module implemented in a form of a software functional module can be stored in a computer-readable storage medium. The described software functional module is stored in a storage medium, and includes several instructions enabling a computer device (which may be a personal computer, or a network device, or the like) or a processor (English: processor) to perform the steps of the methods described in the embodiments of the present application.

It should be understood that the described processor can be a central processing unit (English: Central Processing Unit, CPU for short), or other general purpose processor, a digital signal processor (English: Digital Signal Processor, DSP for short), an application specific integrated circuit (English: Application Specific Integrated Circuit, ASIC for short), etc. The general-purpose processor can be a microprocessor or the processor can also be any conventional processor. The steps of the methods disclosed in combination with the present application can be directly reflected in the completion of execution by the hardware processor or the combination of hardware and software modules in the processor.

The memory may include a high-speed RAM memory, or a non-volatile memory NVM, such as a disk memory, a USB flash disk, a mobile hard disk, a read-only memory, a magnetic disk, an optical disk, or the like.

The bus can be an industry standard architecture (Industry Standard Architecture, ISA) bus, a peripheral component interconnect (Peripheral Component, PCI) bus or an extended industry standard architecture (Extended Industry Standard Architecture, EISA) bus, etc. The bus can be divided into address bus, data bus, control bus, etc. For the convenience of expression, the bus in the figures of the embodiments of the present application is not limited to only one bus or one type of bus.

The described storage medium can be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or an optical disk. The storage medium can be any available medium that can be accessed by a general-purpose or dedicated computer.

An exemplary storage medium is coupled to a processor so that the processor can read information from and write information to the storage medium. Definitely, the storage medium can also be part of the processor. The processor and the storage medium can be located in application specific integrated circuit (Application Specific Integrated Circuits, ASIC for short). Definitely, the processor and the storage medium can also exist in an electronic device or a primary control device as discrete components.

Persons ordinarily skilled in the art may understand that, all or a part of the steps of the foregoing method embodiments may be implemented by program instruction relevant hardware. The foregoing program can be stored in a computer—readable storage medium. When the program runs, the steps of the foregoing method embodiments are performed. The foregoing storage medium includes various mediums capable of storing program codes, such as a ROM, a RAM, a magnetic disk, or an optical disc.

Finally, it should be noted that the foregoing embodiments are merely intended for describing the technical solutions of the embodiments of the present application rather than limiting the present application. Although the embodiments of the present application have been described in detail with reference to the foregoing embodiments, persons ordinarily skilled in the art should understand that they may still make modifications to the technical solutions described in the foregoing embodiments, or make equivalent replacements to some or all technical features therein; however, these modifications or replacements do not make the essence of corresponding technical solutions depart from the scope of the technical solutions in the embodiments of the present application.

1-18. (canceled)

19. A waiting duration determination method, applied to a terminal and comprising:
receiving configuration information, wherein the configuration information comprises N waiting durations corresponding to N location intervals of a satellite, and N is an integer greater than or equal to 2; and
determining a target waiting duration from the N waiting durations based on ready-for-delivery information, wherein the target waiting duration is a waiting duration subsequent to sending the ready-for-delivery information and prior to monitoring response information corresponding to the ready-for-delivery information by the terminal.

20. The method according to claim 19, wherein the determining the target waiting duration from the N waiting durations based on the ready-for-delivery information comprises:
determining the target waiting duration from the N waiting durations based on first information of the ready-for-delivery information.

21. The method according to claim 20, wherein the first information is any of the following information:
first temporal information comprising a sending time of the ready-for-delivery information and a first receiving time of the configuration information;
second temporal information comprising a sending time of the ready-for-delivery information and a second receiving time of first indication information corresponding to the ready-for-delivery information, wherein the first indication information is used to indicate a starting waiting duration corresponding to a starting index in the N waiting durations; and
second indication information corresponding to the ready-for-delivery information, wherein the second indication information is used to indicate the target waiting duration.

22. The method according to claim 21, wherein the first information is the first temporal information, and the configuration information further comprises an update cycle; the determining the target waiting duration from the N waiting durations based on the first information of the ready-for-delivery information comprises:
determining an update period corresponding to each waiting duration based on the first receiving time and the update cycle; and
determining the target waiting duration based on the sending time and the update period corresponding to each waiting duration, wherein the sending time is within the update period corresponding to the target waiting duration.

23. The method according to claim 21, wherein the first information is the second temporal information, and the configuration information further comprises an update cycle; the determining the target waiting duration from the N waiting durations based on the first information of the ready-for-delivery information comprises:
determining, based on the second receiving time and the update cycle, an update period corresponding to each waiting duration between the starting waiting duration corresponding to the starting index and an ending waiting duration, wherein the ending waiting duration is a last-ranked waiting duration of the N waiting durations ranked based on a ranking sequence of the N waiting durations; and
determining the target waiting duration based on the sending time and the update period corresponding to each waiting duration between the starting waiting duration and the ending waiting duration, wherein the sending time is within the update period corresponding to the target waiting duration;
wherein the first indication information is comprised in any of the following information:
a media access control signaling and a radio resource control signaling,
wherein the media access control signaling and the radio resource control signaling are received after the terminal receives the configuration information.

24. The method according to claim 21, wherein the second indication information is comprised in any of the following information:
a media access control signaling and downlink control information,
wherein the media access control signaling and the downlink control information are received after the terminal receives the configuration information.

25. The method according to claim 19, wherein the configuration information is comprised in any of the following information:
system broadcast information and a radio resource control signaling;
wherein a ranking sequence of the N waiting durations corresponds to a ranking sequence of the N location intervals, and the ranking sequence of the N waiting durations corresponds to a motion trajectory of the satellite.

26. A waiting duration determination apparatus, applied to a terminal and comprising:
a memory, a processor and a computer program, wherein the computer program is stored in the memory, the processor, by executing the computer program, is configured to:
receive configuration information, wherein the configuration information comprises N waiting durations corresponding to N location intervals of a satellite, and N is an integer greater than or equal to 2; and
determine a target waiting duration from the N waiting durations based on ready-for-delivery information, wherein the target waiting duration is a waiting duration subsequent to sending the ready-for-delivery information and prior to monitoring response information corresponding to the ready-for-delivery information by the terminal.

27. The waiting duration determination apparatus according to claim 26, wherein the processor is configured to:
determine the target waiting duration from the N waiting durations based on first information of the ready-for-delivery information.

28. The waiting duration determination apparatus according to claim 27, wherein the first information is any of the following information:
first temporal information comprising a sending time of the ready-for-delivery information and a first receiving time of the configuration information;
second temporal information comprising a sending time of the ready-for-delivery information and a second receiving time of first indication information corresponding to the ready-for-delivery information, wherein the first indication information is used to indicate a starting waiting duration corresponding to a starting index in the N waiting durations; and
second indication information corresponding to the ready-for-delivery information, wherein the second indication information is used to indicate the target waiting duration.

29. The waiting duration determination apparatus according to claim 28, wherein the first information is the first temporal information, and the configuration information further comprises an update cycle; the processor is configured to:
determine an update period corresponding to each waiting duration based on the first receiving time and the update cycle; and
determine the target waiting duration based on the sending time and the update period corresponding to each waiting duration, wherein the sending time is within the update period corresponding to the target waiting duration.

30. The waiting duration determination apparatus according to claim 28, wherein the first information is the second temporal information, and the configuration information further comprises an update cycle; the processor is configured to:
determine, based on the second receiving time and the update cycle, an update period corresponding to each waiting duration between the starting waiting duration corresponding to the starting index and an ending waiting duration, wherein the ending waiting duration is a last-ranked waiting duration of the N waiting durations ranked based on a ranking sequence of the N waiting durations; and
determine the target waiting duration based on the sending time and the update period corresponding to each waiting duration between the starting waiting duration and the ending waiting duration, wherein the sending time is within the update period corresponding to the target waiting duration;
wherein the first indication information is comprised in any of the following information:
a media access control signaling and a radio resource control signaling,
wherein the media access control signaling and the radio resource control signaling are received after the terminal receives the configuration information.

31. The waiting duration determination apparatus according to claim 28, wherein the second indication information is comprised in any of the following information:
a media access control signaling and downlink control information,
wherein the media access control signaling and the downlink control information are received after the terminal receives the configuration information.

32. The waiting duration determination apparatus according to claim 26, wherein the configuration information is comprised in any of the following information:
system broadcast information and a radio resource control signaling;
wherein a ranking sequence of the N waiting durations corresponds to a ranking sequence of the N location intervals, and the ranking sequence of the N waiting durations corresponds to a motion trajectory of the satellite.

33. A non-transitory computer-readable storage medium, stored a computer program, and a processor, when executing the computer program, is configured to:
receive configuration information, wherein the configuration information comprises N waiting durations corresponding to N location intervals of a satellite, and N is an integer greater than or equal to 2; and
determine a target waiting duration from the N waiting durations based on ready-for-delivery information, wherein the target waiting duration is a waiting duration subsequent to sending the ready-for-delivery information and prior to monitoring response information corresponding to the ready-for-delivery information by the terminal.

34. The non-transitory computer-readable storage medium according to claim 33, wherein the processor is configured to:
determine the target waiting duration from the N waiting durations based on first information of the ready-for-delivery information.

35. The non-transitory computer-readable storage medium according to claim 34, wherein the first information is any of the following information:
first temporal information comprising a sending time of the ready-for-delivery information and a first receiving time of the configuration information;
second temporal information comprising a sending time of the ready-for-delivery information and a second receiving time of first indication information corresponding to the ready-for-delivery information, wherein the first indication information is used to indicate a starting waiting duration corresponding to a starting index in the N waiting durations; and
second indication information corresponding to the ready-for-delivery information, wherein the second indication information is used to indicate the target waiting duration.

36. The non-transitory computer-readable storage medium according to claim 35, wherein the first information is the first temporal information, and the configuration information further comprises an update cycle; the processor is configured to:
determine an update period corresponding to each waiting duration based on the first receiving time and the update cycle; and
determine the target waiting duration based on the sending time and the update period corresponding to each waiting duration, wherein the sending time is within the update period corresponding to the target waiting duration.

37. The non-transitory computer-readable storage medium according to claim 35, wherein the first information is the second temporal information, and the configuration information further comprises an update cycle; the processor is configured to:
determine, based on the second receiving time and the update cycle, an update period corresponding to each waiting duration between the starting waiting duration corresponding to the starting index and an ending waiting duration, wherein the ending waiting duration is a last-ranked waiting duration of the N waiting durations ranked based on a ranking sequence of the N waiting durations; and
determine the target waiting duration based on the sending time and the update period corresponding to each waiting duration between the starting waiting duration and the ending waiting duration, wherein the sending time is within the update period corresponding to the target waiting duration;
wherein the first indication information is comprised in any of the following information:
a media access control signaling and a radio resource control signaling,
wherein the media access control signaling and the radio resource control signaling are received after the terminal receives the configuration information.

38. The non-transitory computer-readable storage medium according to claim 35, wherein the second indication information is comprised in any of the following information:
a media access control signaling and downlink control information,
wherein the media access control signaling and the downlink control information are received after the terminal receives the configuration information.
